(19) United States
(12) Patent Application Publication
(10) Pub. No.: US 2022/0253402 A1
(43) Pub. Date: Aug. 11, 2022

(54) BLOCKCHAIN MINING PLATFORM

(71) Applicant: OVERALLSKY, INC., Cary, NC (US)

(72) Inventors: Kathleen M. Hobson, Cary, NC (US); Robert W. Hobson, Cary, NC (US); Richard L. Bigelow, Mountaintop, PA (US); Henry S. Hodge, New York, NY (US)

(21) Appl. No.: 17/665,565

(22) Filed: Feb. 6, 2022

Related U.S. Application Data
(60) Provisional application No. 63/146,897, filed on Feb. 8, 2021.

(51) Int. Cl. G06F 15/80; B64B 1/06; H02J 7/35; B64D 27/24

(52) U.S. Cl. CPC G06F 15/80; B64B 1/06; B64D 2041/002; B64D 27/24; H02J 7/35

(57) ABSTRACT

A blockchain mining platform that comprises an airship utilizing an innovative lift mechanism featuring dynamic and static vacuum chambers. Solar panels power the vast array of computers required for efficient and cost effective blockchain mining. Internet connectivity would be accomplished by communication with satellites or by microwave transmission to ground station. In alternate modes, different types of airships with the ability to stay aloft for extended periods of time could be used.

### CROSS-REFERENCE TO RELATED APPLICATIONS

This non-provisional patent application claims priority to U.S. Provisional Patent Application Ser. No. 63/146,897 filed on Feb. 8, 2021.

This non-provisional patent application is further related to U.S. patent application Ser. No. 16/845,200 to Hobson, “Airship With Vacuum Based Lift Methodology” which is hereby incorporated herein in its entirety by reference.

### FIELD OF THE INVENTION

The present invention is directed to a blockchain mining platform, and more particularly to an airborne vehicle configured with multiple solar panels and mining computers, wherein the airborne vehicle may be an airship and the airship may use a vacuum to provide the lifting force to elevate the airship above the ground.

### BACKGROUND OF THE INVENTION

Blockchain mining has become a very important aspect of the blockchain and cryptocurrency. One of the drawbacks of blockchain mining is the enormous amount of electricity that is required in order to power the vast array of computers that are used to mine a blockchain. Blockchain miners frequently search for areas that have abundant low cost electricity in order to minimize the cost of mining. As low cost electricity areas become harder to find, it is becoming incumbent on blockchain miners to be innovative in finding new ways to sustain their mining activities at a reasonable cost.

For ease of understanding, the present invention is described in terms of a vacuum airship. However, the essence of this invention is applicable to any type of airborne vehicle or airship or any other device capable of incorporating the large bank of computers necessary to efficiently mine blockchains and furthermore designed to stay aloft above the troposphere for extended periods of time.

The present invention presents an alternative to land based blockchain mining operations. In particular, the present invention discloses the use of airships with vacuum lift technology as a platform for blockchain mining. The vacuum airship would elevate to between 30,000 and 70,000 feet in altitude, i.e. generally remaining in the troposphere. In general, the vacuum airship can be configured with large arrays of solar panels that serve to power the large array of computers engaged in the blockchain mining operation. Internet connection can be directly to satellites.

### SUMMARY OF THE INVENTION

The present invention is directed to a blockchain mining platform that comprises an airship using vacuums to provide the lifting force to elevate the airship above the ground and keep it in an elevated position in the earth's upper atmosphere. The airship is further configured with multiple solar panels to provide the significant amounts of electricity that are needed to efficiently power the array of computers required to optimize a blockchain mining operation. The solar panels may be affixed on the external surfaces of the airship or may be on the interior of the airship positioned next to transparent or translucent windows.

The sides of the airship will be equipped with additional solar panels dedicated to the mining effort which would face towards the sun so that they will get the most amount of sunlight. These solar panels would be used to power desktop computers or similar devices which are used to blockchain mine. In general terms, each of the computers uses around 1200 watts of power and each of the standard solar panels that are 65 inches by 39 inches are able to generate 400 watts of power in an hour. In the stratosphere the air ship would be able to connect to the internet through the use of satellites the same way in which commercial airplanes are able to connect to the internet. Additionally, microwave communication links to ground based stations could also be used to connect to the internet. It is expected that the solar panels so configured will be highly efficient in producing electricity to power the computers since the sunlight will not be attenuated by clouds, atmospheric dust, rain or pollution.

Cleaning of solar panel collector surfaces may be an issue. Therefore, while many of the solar panels will be mounted on the exterior of the airship, some may be mounted or positioned in interior areas of the airship next to translucent or transparent windows which allow sunlight to impinge on the solar collectors. This will allow easy access to and periodic cleaning of the internally installed solar panel surfaces.

In an alternate mode, specially equipped drones or similar hovering devices may be used to clean the solar panels on the exterior of the airship. The drones would operate on electric battery power. The batteries would be charged by electricity from the solar panels while the drones were docked and not operating.

In an alternate mode, some of the solar panels may be mounted on motorized structures that allow the panels to “follow the sun” thereby maximizing the electricity produced by these solar panels.

The lift to elevate the airship is provided by a series of accordion-like airtight structures (referred to as dynamic chambers) inserted in the interior of the ultra large airship. As the accordion-like dynamic chambers are expanded using engines or motors, a vacuum space is expanded in the dynamic chambers and air is displaced, thereby producing upward lift.

Additionally, rigid chambers (referred to as static chambers) will be used. In the case of static chambers, a vacuum would be drawn using engines or motors to evacuate air from the chamber. The rigid chambers are used to make the entire structure neutrally buoyant.

A 600 ft×600 ft×600 ft dynamic chamber could produce lift sufficient to lift approximately 683 twenty-foot equivalent unit (TEU) of mass where twenty foot refers to a standard twenty-foot container. The theory of operation would be that the dynamic chambers are expanded to achieve vacuum volumes sufficient to lift the ultra large airship into the jet stream. By riding the Jetstream, the ultra large airship could travel around the world in a few days.

The blockchain mining airship would be configured with living quarters, maintenance and repair shops, a warehouse for spare parts, and recreation areas for a crew to operate the airship and computer technicians to operate the blockchain mining operation. The blockchain airship would also have docking ports where supply aircraft from the earth could resupply the airship and transport passengers back and forth from the ground to the airship. In such a configuration, the blockchain airship could stay aloft indefinitely. Due to its maneuverability, the airship would have the ability to “follow the sun” in order to optimize the amount of solar electricity generated per day.

Owing to the significant size of the standard Vacuum Airship, a blockchain mining operation could be installed in one of the envisioned special cargo or living spaces on the standard Vacuum Airship. There is ample room for as many solar panels as are required. Residual heat removal would not be an issue since the ultimate heat sink is right outside the exterior of the vacuum airship. Some accommodation may have to be made for enhanced internet connections. However, it is envisioned that internet connections directly to satellites would be better than ground based internet connections or ground to satellite connections due to the absence of clouds, pollution and competing signals.

While it is envisioned that most of the power for the blockchain airship would come from solar panels, backup systems incorporating power sources such as wind turbines, fuel cells, or other sources of energy would be incorporated into the blockchain airship. These alternate sources would ensure that power would continue to be delivered to the blockchain mining computers even when the sun no longer shines on the solar panels. In addition, large banks of batteries would be charged during sunlight hours to further ensure power to the computers on a 24/7 basis as well as emergency backup power. Nonetheless, residual heat from the banks of computers could be used to heat most of the living and some of the cargo spaces on the airship. Any additional electricity generated by the solar cells would be used to charge back batteries.

In an alternate embodiment of the present invention, smaller Vacuum Airships could be designed and configured specifically for the blockchain mining operation or other similar operations that would require large amounts of electricity, a robust heat sink and the ability to remain on station indefinitely. In addition, other types of airships could be used. Airships with helium or hot air may be suitable especially if they are able to stay aloft indefinitely.

In a further embodiment of the present invention, the vacuum airship blockchain mining platform may be tethered to the ground in order to provide secure communications or deliver excess electricity generated by the solar panels to the land based electrical grid.

In a further embodiment of the present invention, it is envisioned that the stacks of computers may be immersed in a carbon dioxide atmosphere or bath in order to cool the computers and provide protection against fire.

In a further embodiment of the present invention, the vacuum airship blockchain mining platform may be used as a relay station for transmission of laser beams through the upper atmosphere without the atmospheric interference characteristic in lower elevations of the atmosphere.

### DESCRIPTION OF THE PRIOR ART

There are many examples of blockchain mining facilities in the prior art. However, virtually all of these are ground/land based. In addition, there are many examples of airships in the prior art. Virtually all the airships disclosed in the prior art incorporate the use of lighter than air gases such as Helium or Hydrogen as the lifting mechanism. The present invention dispenses with the use of lighter than air gases as the lift mechanism and instead uses the concept of sustainable vacuums to provide the lift needed.

There appear to be no examples of the combined blockchain mining operation and an airship with vacuum lift technology in the prior art. The present invention presents this concept. The setup for the blockchain mining operation on the airship will be similar to that which is used on the earth's surface powered by solar power. The computers could be stacked on top of each other in an XYZ configuration to allow for the most amount of computing power in the smallest amount of space possible. Alternatively, the computers can be spread out in the XY plane if space economy is not imperative. The solar panels will be positioned on the outside of the ship so that they will get the maximum amount of sunlight. Enhanced wiring and surge protection may be implemented to protect the mining operation.

### BRIEF DESCRIPTION OF THE DRAWINGS

Further aspects of the instant invention will be more readily appreciated upon review of the detailed description of the preferred embodiments included below when taken in conjunction with the accompanying drawings, of which:

FIG. 1A is a perspective view of the Blockchain Mining Platform airship 10 showing positioning of the dynamic and/or static chambers within the airframe. The blockchain mining operation can be located in any interior space. This figure also shows the thrusters 20 which can position the airship to capture maximum solar power.

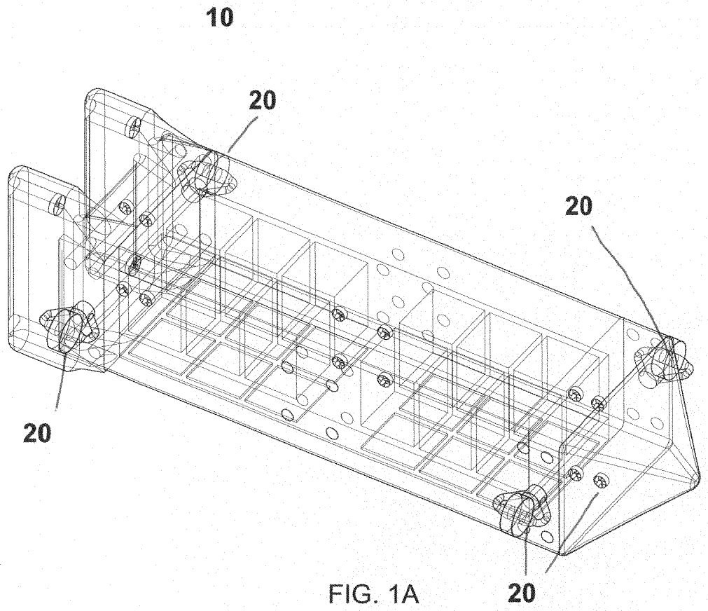

FIG. 1B is an exploded view of the Blockchain Mining Platform airship.

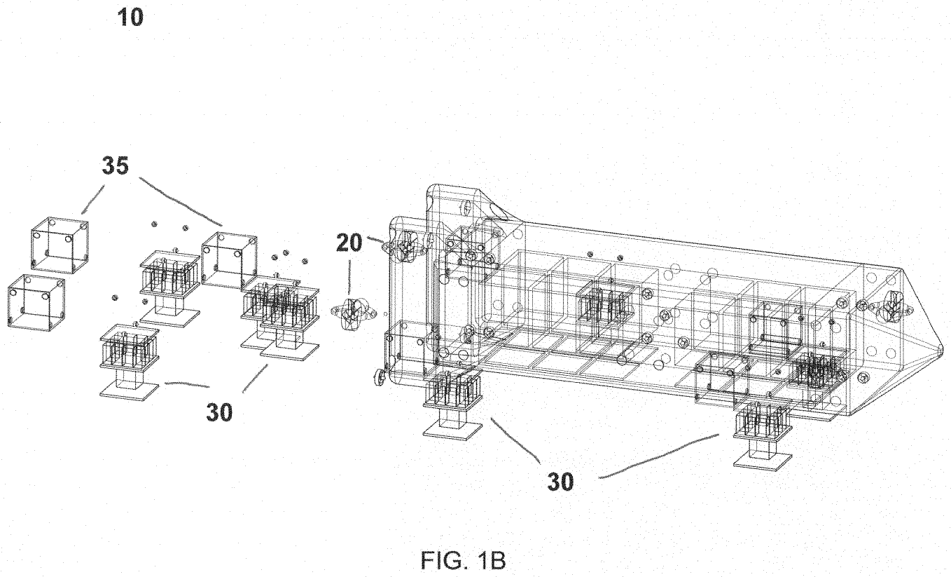

FIGS. 2A and 2B show the dynamic chambers in the collapsed and expanded positions.

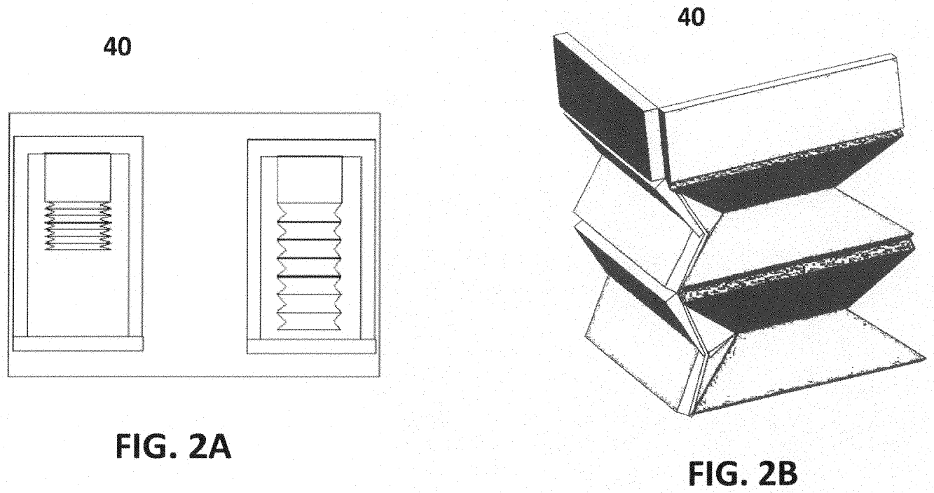

FIG. 3 shows a typical blockchain mining setup with multiple stacks of computers engaging in the mining operation.

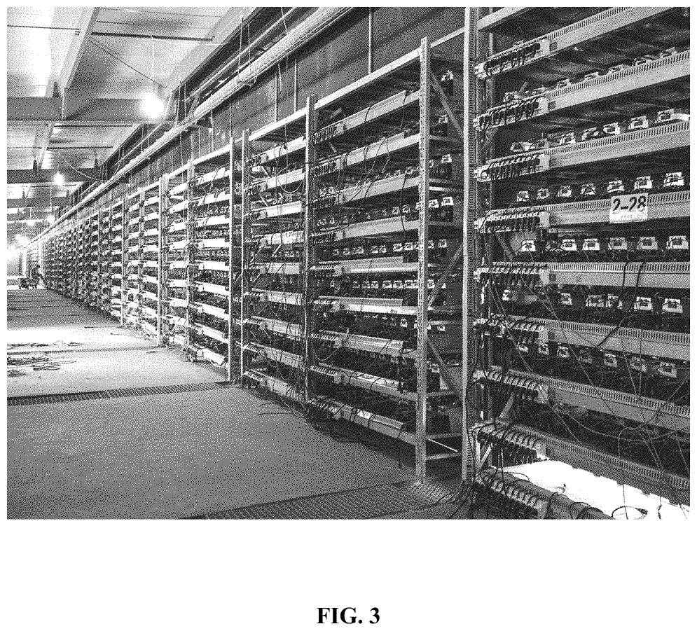

The following is claimed:

1. A blockchain mining platform comprising an airborne vehicle designed to stay aloft above the troposphere for extended periods of time, further comprising:
a. An array of personal computers or similar devices sufficient to mine blockchains,
b. An array of solar panels exterior to the airborne vehicle that produce electricity,
c. A second array of solar panels interior to the vehicle that may be stationed next to windows or translucent structures such that sunlight will impinge on the interior solar panels thereby producing an alternate source of electricity.
d. A means for communicating with extra-terrestrial satellites that allow connectivity to the internet.

2. A blockchain mining platform as in claim 1 wherein the airborne vehicle is an airship.

3. A blockchain mining platform as in claim 1 wherein the airborne vehicle is a vacuum airship.

4. A blockchain mining platform as in claim 1 wherein the exterior solar panels are mounted on the sides of said airborne vehicle.

5. A blockchain mining platform as in claim 1 wherein the interior solar panels are placed next to windows or translucent structures allowing sunlight to impinge on the panels.

6. A blockchain mining platform as in claim 1 wherein the electricity produced by the solar panels powers the array of blockchain mining computers.

7. A blockchain mining platform as in claim 1 wherein some of the solar panels are mounted on motorized platforms allowing said panels to move to optimal direction of the sun.

8. A blockchain mining platform as in claim 1 wherein internet communication is established with satellites or via microwave transmission to earth based internet connections.

9. An apparatus and method for mining blockchains comprising:
a. an airborne vehicle designed to stay aloft for extended periods of time, further comprising:
b. An array of personal computers or similar devices sufficient to mine blockchains,
c. An array of solar panels exterior to the airborne vehicle that produce electricity sufficient to operate the array of computers engaged in the blockchain mining process,
d. A second array of solar panels interior to the vehicle that may be stationed next to windows or translucent structures such that sunlight will impinge on the interior solar panels thereby producing an alternate source of electricity.
e. A means for communicating with extra-terrestrial satellites that allow connectivity to the internet.
f. A further means for communicating with land based internet systems via microwave transmission.

10. A blockchain mining platform as in claim 9 wherein the airborne vehicle is an airship.

11. A blockchain mining platform as in claim 9 wherein the airborne vehicle is a vacuum airship.

12. A blockchain mining platform as in claim 9 wherein the exterior solar panels are mounted on the sides of said airborne vehicle.

13. A blockchain mining platform as in claim 9 wherein the interior solar panels are placed next to windows or translucent structures allowing sunlight to impinge on the panels.

14. A blockchain mining platform as in claim 9 wherein the electricity produced by the solar panels powers the array of blockchain mining computers.

15. A blockchain mining platform as in claim 9 wherein some of the solar panels are mounted on motorized platforms allowing said panels to move to optimal direction of the sun.

16. A blockchain mining platform as in claim 9 wherein internet communication is established with satellites or via microwave transmission to earth based internet connections.

17. A blockchain mining platform as in claim 9 wherein residual heat from the blockchain mining computers heats living and storage compartments of the airborne vehicle.

18. A blockchain mining platform as in claim 9 wherein excess electricity generated by the solar panels would charge backup batteries.
